(19) United States
(12) Patent Application Publication
(10) Pub. No.: US 2014/0101588 A1
(43) Pub. Date: Apr. 10, 2014

(54) MOBILE TERMINAL AND METHOD FOR CONTROLLING THE SAME

(71) Applicants: Minkyoung CHANG, Seoul (KR); Yunmi Kwon, Seoul (KR); Arim Kwon, Seoul (KR)

(72) Inventors: Minkyoung CHANG, Seoul (KR); Yunmi Kwon, Seoul (KR); Arim Kwon, Seoul (KR)

(21) Appl. No.: 14/046,087

(22) Filed: Oct. 4, 2013

(30) Foreign Application Priority Data
Oct. 8, 2012 (KR) 10-2012-0111131

(51) Int. Cl. G06F 3/0488; G06F 3/0482

(52) U.S. Cl. CPC G06F 3/0488; G06F 3/0482
USPC 715/769; 715/810; 715/815

(57) ABSTRACT

A mobile terminal and a method for controlling the mobile terminal are disclosed. The mobile terminal may include a touchscreen and a controller configured to control operation of the mobile terminal based on inputs at the touchscreen. A screen that includes at least one object for an application program may be displayed on the touchscreen. A graphical object associated with a prescribed function may also be displayed on the touchscreen. In response to a prescribed touch input that associates the graphical object with the application program object, the prescribed function may be performed for the application program object.

### CROSS-REFERENCE TO RELATED APPLICATION(S)

This application claims priority under 35 U.S.C. §119 to Korean Application No. 10-2012-0111131 filed in Korea on Oct. 8, 2012, whose entire invention is hereby incorporated by reference.

### BACKGROUND

1. Field

The present invention relates to a mobile terminal and a method for controlling the same, and more particularly, to a mobile terminal, which is capable of implementing various functions executable on mobile terminals through interaction with an object, and a method for controlling the same.

2. Background

With the rapid development of hardware and software technologies relating to various electronic devices including a mobile terminal, the electronic devices can provide and store a wide variety of functions and information. Accordingly, various information can be provided on a screen of an electronic device. Moreover, a mobile terminal with a touchscreen allows a user to access various information provided on the touchscreen just by touching the touchscreen.

The above references are incorporated by reference herein where appropriate for appropriate teachings of additional or alternative details, features and/or technical background.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention. In the drawings:

The embodiments will be described in detail with reference to the following drawings in which like reference numerals refer to like elements wherein:

FIG. 1 is a block diagram of a mobile terminal in accordance with an exemplary embodiment of the present invention;

FIG. 2 is a conceptual view illustrating a proximity depth of the proximity sensor;

FIG. 3 is a flowchart illustrating a method for controlling the mobile terminal in accordance with a first exemplary embodiment of the present invention;

FIGS. 4 to 9B are views for explaining the method for controlling the mobile terminal in accordance with the first exemplary embodiment of the present invention;

FIG. 10 is a flowchart of a method for controlling the mobile terminal in accordance with a second exemplary embodiment of the present invention;

FIGS. 11A to 11C are views for explaining the method for controlling the mobile terminal in accordance with the second exemplary embodiment of the present invention;

FIG. 12 is a flowchart of a method for controlling the mobile terminal in accordance with a third exemplary embodiment of the present invention; and

FIGS. 13A to 13C are views for explaining the method for controlling the mobile terminal in accordance with the third exemplary embodiment of the present invention.

FIGS. 14 and 15 are views for explaining an example of repositioning an object in accordance with an exemplary embodiment of the present invention.

### DETAILED DESCRIPTION

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable those skilled in the art to thoroughly understand the teaching of the present invention and to completely inform the scope of the present invention and the exemplary embodiment is just defined by the scope of the appended claims.

The mobile terminal described in this specification may include a smart phone, a laptop computer, a digital broadcasting terminal, a personal digital assistant (PDA), a portable multimedia player (PMP), a navigation system, etc.

Hereinafter, the present invention will be described in detail with reference to the accompanying drawings.

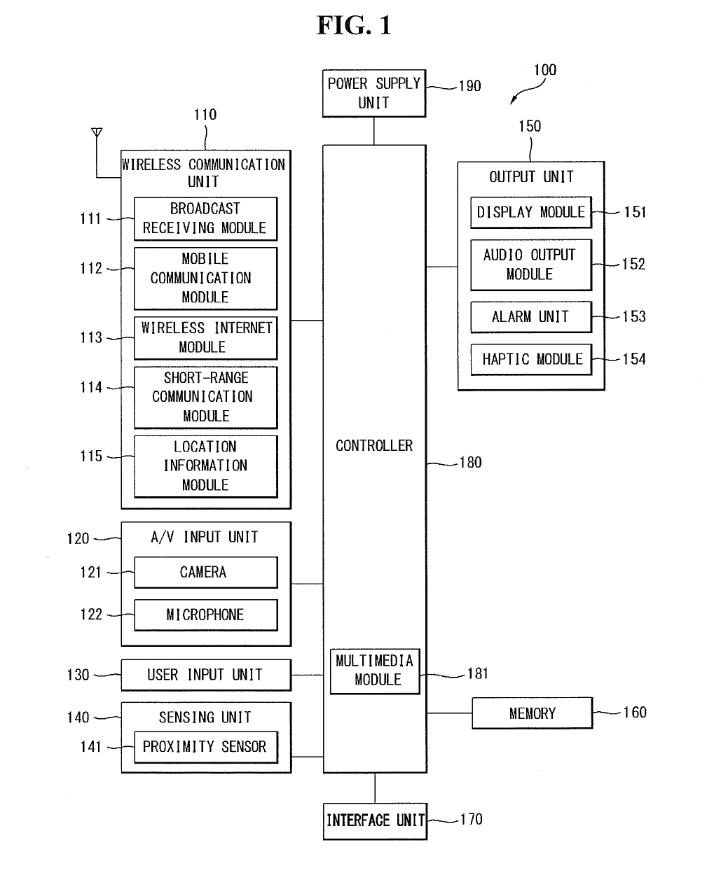

FIG. 1 is a block diagram of a mobile terminal in accordance with an exemplary embodiment of the present invention.

The mobile terminal 100 includes a wireless communication unit 110, an A/V (AudioNideo) input unit 120, a user input unit 130, a sensing unit 140, an output unit 150, a memory 160, an interface unit 170, a controller 180, and a power supply unit 190, etc. FIG. 1 shows the mobile terminal as having various components, but implementing all of the illustrated components is not a requirement. Greater or fewer components may alternatively be implemented.

The components will now be sequentially described.

The wireless communication unit 110 may include one or more modules allowing radio communication between the mobile terminal 100 and a wireless communication system or between the mobile terminal 100 and a network in which the mobile terminal 100 is located. For example, the wireless communication unit 110 includes a broadcast receiving module 111, a mobile communication module 112, a wireless Internet module 113, a short-range communication module 114, and a location information module 115.

The broadcast receiving module 111 receives broadcast signals and/or broadcast-associated information from an external broadcast management server via a broadcast channel.

The broadcast channel may include a satellite channel and/or a terrestrial channel. The broadcast management server may be a server that generates and transmits a broadcast signal and/or broadcast-associated information or a server that receives a previously generated broadcast signal and/or broadcast-associated information and transmits the same to a terminal. The broadcast signal may include a TV broadcast signal, a radio broadcast signal, a data broadcast signal, and the like. Also, the broadcast signal may further include a combination of a TV or radio broadcast signal and a data broadcast signal.

The broadcast associated information may refer to information associated with a broadcast channel, a broadcast program or a broadcast service provider. The broadcast-associated information may also be provided via a mobile communication network and, in this instance, the broadcast-associated information may be received by the mobile communication module 112.

The broadcast signal may exist in various forms. For example, the broadcast signal may exist in the form of an electronic program guide (EPG) of the digital multimedia broadcasting (DMB) system, and electronic service guide (ESG) of the digital video broadcast-handheld (DVB-H) system, and the like.

The broadcast receiving module 111 receives broadcast signals by using various types of broadcast systems. In particular, the broadcast receiving module 111 can receive a digital broadcast using a digital broadcast system such as the multimedia broadcasting-terrestrial (DMB-T) system, the digital multimedia broadcasting-satellite (DMB-S) system, the digital video broadcast-handheld (DVB-H) system, the integrated services digital broadcast-terrestrial (ISDB-T) system, etc. The broadcast receiving module 111 can also be configured to be suitable for all broadcast systems that provide a broadcast signal as well as the above-mentioned digital broadcast systems.

The broadcast signals and/or broadcast-associated information received via the broadcast receiving module 111 may be stored in the memory 160.

The mobile communication module 112 transmits and/or receives radio signals to and/or from at least one of a base station, an external terminal and a server. Such radio signals may include a voice call signal, a video call signal, or various types of data according to text and/or multimedia message transmission and/or reception.

The wireless Internet module 113 refers to a module for wireless Internet access. The wireless internet module 113 may be internally or externally coupled to the mobile terminal 100. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short-range communications. Some examples of short-range communication technology include Bluetooth™, Radio Frequency Identification (RFID), Infrared Data Association (IrDA), Ultra-WideBand (UWB), ZigBee™, and the like.

The location information module 115 is a module for checking or acquiring a location or position of the mobile terminal. A global positioning system (GPS) module is a representative example of the location information module 115.

The location information module 115 may acquire location information by using a global navigation satellite system (GNSS). The GPS module 115 may calculate information related to the distance from one point (entity) to three or more satellites and information related to time at which the distance information was measured, and applies trigonometry to the calculated distance, thereby calculating three-dimensional location information according to latitude, longitude, and altitude with respect to the one point (entity). In addition, a method of acquiring location and time information by using three satellites and correcting an error of the calculated location and time information by using another one satellite may be also used. The GPS module 115 may also continuously calculate the current location in real time and also calculate speed information by using the continuously calculated current location.

With reference to FIG. 1, the A/V input unit 120 is configured to receive an audio or video signal, and includes a camera 121 and a microphone 122. The camera 121 processes image frames of still pictures or video obtained by an image sensor in a video call mode or photographing mode. The processed image frames can then be displayed on a display module 151.

The image frames processed by the camera 121 may be stored in the memory 160 or transmitted externally via the wireless communication unit 110. Two or more cameras 121 may also be provided according to the configuration of the mobile terminal.

The microphone 122 receives an external audio signal via a microphone in a phone call mode, a recording mode, a voice recognition mode, and the like, and processes the received audio signal into electric audio data. The processed audio data may then be converted for output into a format transmittable to a mobile communication base station via the mobile communication module 112 for the phone call mode. The microphone 122 may also implement various types of noise canceling algorithms to cancel noise generated when receiving external audio signals.

The user input unit 130 generates input data from commands entered by a user to control various operations of the mobile terminal. The user input unit 130 may include a keypad, a dome switch, a touch pad (constant voltage/capacitance), a jog wheel, a jog switch, and the like.

The sensing unit 140 detects a current status of the mobile terminal 100 such as an opened or closed state of the mobile terminal 100, a location of the mobile terminal 100, the presence or absence of user contact with the mobile terminal 100, the orientation of the mobile terminal 100, acceleration or deceleration of the mobile terminal 100, etc., and generates sensing signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 also includes a proximity sensor 141.

The output unit 150 is configured to provide outputs in a visual, audible, and/or tactile manner. The output unit 150 includes the display module 151, an audio output module 152, an alarm unit 153, a haptic module 154, and the like.

The display module 151 can display information processed in the mobile terminal 100. For example, when the mobile terminal 100 is in a phone call mode, the display module 151 can display a User Interface (UI) or a Graphic User Interface (GUI) associated with a phone call. The display module 151 displays a captured and/or received image, UI, or GUI when the mobile terminal 100 is in the video call mode or the photographing mode.

The display module 151 may also include at least one of a Liquid Crystal Display (LCD), a Thin Film Transistor-LCD (TFT-LCD), an Organic Light Emitting Diode (OLED) display, a flexible display, a three-dimensional (3D) display, or the like.

Some of these displays may also be configured to be transparent or light-transmissive to allow for viewing of the exterior, which is called transparent displays. An example transparent display is a TOLED (Transparent Organic Light Emitting Diode) display, or the like. A rear structure of the display module 151 may be also light-transmissive. With this configuration, the user can view an object positioned at the rear side of the terminal body through the region occupied by the display module 151 of the terminal body.

The mobile terminal 100 may include two or more display modules 151 according to its particular desired embodiment. For example, a plurality of display modules may be separately or integrally disposed on one surface of the mobile terminal, or may be separately disposed on mutually different surfaces.

When the display module 151 and a sensor (hereinafter referred to as a ‘touch sensor’) for detecting a touch operation are overlaid in a layered manner to form a touchscreen, the display module 151 can function as both an input device and an output device. The touch sensor may have a form of a touch film, a touch sheet, a touch pad, and the like

The touch sensor may be configured to convert pressure applied to a particular portion of the display module 151 or a change in the capacitance or the like generated at a particular portion of the display module 151 into an electrical input signal. The touch sensor may also be configured to detect the pressure when a touch is applied, as well as the touched position and area.

When there is a touch input with respect to the touch sensor, a corresponding signal(s) is transmitted to a touch controller, and the touch controller processes the signal(s) and transmits corresponding data to the controller 180. Accordingly, the controller 180 can recognize which portion of the display module 151 has been touched.

With reference to FIG. 1, the proximity sensor can be located in an internal region of the mobile terminal, surrounded by the touchscreen, or near the touchscreen. The proximity sensor is a sensor for detecting the presence or absence of an object approaching a predetermined sensing area or an object located near the proximity sensor by using the force of electromagnetism or infrared rays without a physical contact. Thus, the proximity sensor has a considerably longer life span compared with a contact type sensor, and can be utilized for various purposes.

Examples of the proximity sensor include a transmission type photoelectric sensor, a direct reflection type photoelectric sensor, a mirror-reflection type photo sensor, a high-frequency oscillation proximity sensor, a capacitance type proximity sensor, a magnetic proximity sensor, an infrared proximity sensor, and the like.

When the touchscreen is the capacitance type, proximity of the pointer is detected by a change in electric field according to the proximity of the pointer. In this instance, the touchscreen (touch sensor) may be classified as a proximity sensor.

In the following description, for the sake of brevity, an action in which a pointer approaches the touchscreen without contacting the touchscreen may be called a proximity touch, whereas an action in which a pointer actually touches the touchscreen may be called a contact touch. The location of the touchscreen proximity-touched by the pointer may be the position of the pointer that vertically opposes the touchscreen when the pointer performs the proximity touch.

The proximity sensor senses a proximity touch and a proximity touch pattern (for example, a proximity touch distance, a proximity touch direction, a proximity touch velocity, a proximity touch time, a proximity touch position, a proximity touch moving state, etc.). Information corresponding to the sensed proximity touch action and proximity touch pattern can be displayed on the touchscreen.

The audio output module 152 may output audio data received from the wireless communication unit 110 or stored in the memory 160 in a call signal reception mode, a call mode, a recording mode, a voice recognition mode, a broadcast reception mode, and the like. Also, the audio output module 152 outputs a sound signal (e.g. an incoming call ringtone, an incoming message ringtone, etc.) related to a function performed by the mobile terminal 100. The audio output module 152 may include a receiver, a speaker, a buzzer, etc.

The alarm unit 153 outputs a signal for indicating the occurrence of an event in the mobile terminal 100. Examples of events that occur in the mobile terminal may include call signal reception, message reception, key signal input, touch input etc. The alarm unit 153 may signal the occurrence of an event in other forms than a video or audio signal, for example, vibration. The video or audio signal may be output through the display module 151 or the sound output module 152 as well.

The haptic module 154 produces various tactile effects that can be felt by a user. Examples of the tactile effects include vibration. The strength and pattern of a vibration generated by the haptic module 154 may be controlled. For example, different vibrations may be first combined and then output, or sequentially output.

The haptic module 154 may generate various haptic effects including a vibration, an effect caused by such a stimulus as a pin array vertically moving against a contact skin surface, a jet power of air via outlet, a suction power of air via inlet, a skim on a skin surface, a contact of an electrode, an electrostatic power and the like, and/or an effect by hot/cold sense reproduction using an endothermic or exothermic device as well as the vibration.

The haptic module 154 may provide the haptic effect via direct contact. The haptic module 154 may enable a user to experience the haptic effect via muscular sense of a finger, an arm and/or the like. Two or more haptic modules 154 may be provided according to a configuration of the mobile terminal 100.

The memory 160 may store a program for operations of the controller 180. The memory 160 may temporarily store input/output data (e.g., phonebook, message, still picture, moving picture, etc.). The memory 160 may store data of vibration and sound in various patterns outputted in case of a touch input to the touchscreen.

The memory 160 may also include at least one type of storage medium including a flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with external devices connected with the mobile terminal 100. The external devices can transmit data to an external device, receive and transmit power to each element of the mobile terminal 100, or transmit internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may also be a chip that stores various types of information for authenticating the authority of using the mobile terminal 100, and may include a user identity module (UIM), a subscriber identity module (SIM) a universal subscriber identity module (USIM), and the like. A device having the identification module (referred to as an ‘identifying device’, hereinafter) may take the form of a smart card. Accordingly, the identifying device can be connected with the mobile terminal 100 via a port.

When the mobile terminal 100 is connected with an external cradle, the interface unit 170 can also serve as a passage to allow power from the cradle to be supplied therethrough to the mobile terminal 100, or serve as a passage to allow various command signals input by the user from the cradle to be transferred to the mobile terminal therethrough. Various command signals or power input from the cradle may operate as signals for recognizing that the mobile terminal is properly mounted on the cradle.

The controller 180 controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180, or may be configured separately from the controller 180.

The controller 180 can also perform pattern recognition processing to recognize a handwriting input or a picture drawing input performed on the touchscreen as characters or images, respectively.

The power supply unit 190 receives external power or internal power and supplies appropriate power required for operations of the respective elements under the control of the controller 180.

Various embodiments described herein may be implemented in a recording medium readable by a computer or a computer-like device by various means, for example, software, hardware, or a combination thereof.

In a hardware configuration, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180.

In a software configuration, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

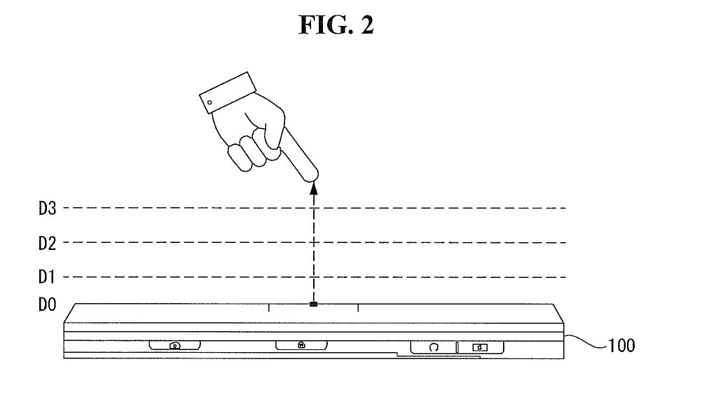

FIG. 2 is a conceptual view illustrating a proximity depth of the proximity sensor.

As shown in FIG. 2, when a pointer such as the user's finger approaches the touchscreen, the proximity sensor 1 disposed within or near the touchscreen detects it and outputs a proximity signal.

The proximity sensor may be configured to output a different proximity signal according to the distance (referred to as a ‘proximity depth’, hereinafter) between the proximity-touched pointer and the touchscreen.

A distance from which a proximity signal is outputted when a point approaches the touchscreen, is called a detection distance. The proximity depth can be known by comparing proximity signals outputted from proximity sensors with different detection distances.

FIG. 2 also shows the section of the touchscreen with the proximity sensor for detecting, for example, three proximity depths. The proximity sensor may detect less than three proximity depths or four or more proximity depths.

In more detail, when the pointer is fully brought into contact with the touchscreen d0, this position is recognized as a contact touch. When the pointer is positioned to be spaced apart by shorter than a distance d1 on the touchscreen, this position is recognized as a proximity touch with a first proximity depth.

If the pointer is positioned to be spaced apart by the distance longer than the distance d1 but shorter than a distance d2 on the touchscreen, this position is recognized as a proximity touch with a second proximity depth. Also, if the pointer is positioned to be spaced apart by the distance longer than the distance d2 but shorter than a distance d3, this position is recognized as a proximity touch with a third proximity depth. If the pointer is positioned to be spaced apart by longer than the distance d3 on the touchscreen, this position is recognized that the proximity touch has been released.

Accordingly, the controller 180 can recognize the proximity touches as various input signals according to the proximity depths and proximity positions of the pointer, and control various operations according to the various input signals.

Generation operations and functions of the mobile terminal 100 in accordance with one exemplary embodiment of the present invention have been described so far with reference to FIGS. 1 and 2.

Hereinafter, exemplary embodiments of the present invention will be described.

In the present invention, it is assumed that the display module 151 is a touchscreen 151, for convenience of description. As described above, the touchscreen 151 may perform both functions of displaying and inputting information. It is however to be noted that the present invention is not limited thereto. Furthermore, the touch described in this document may comprise both the contact touch and the proximity touch.

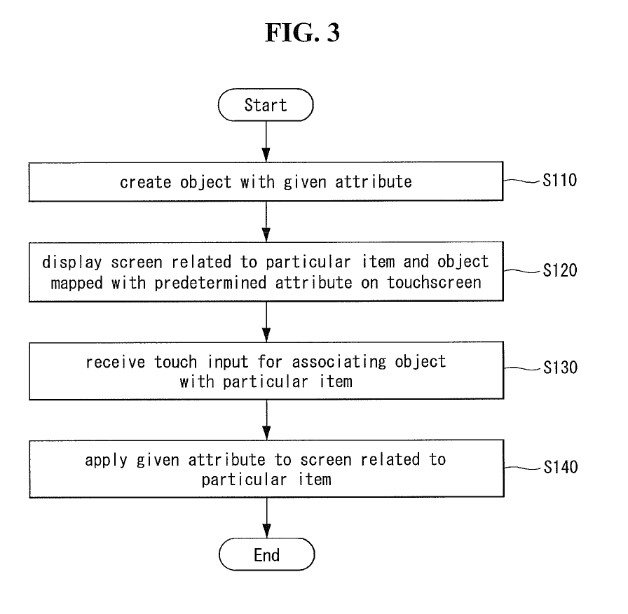

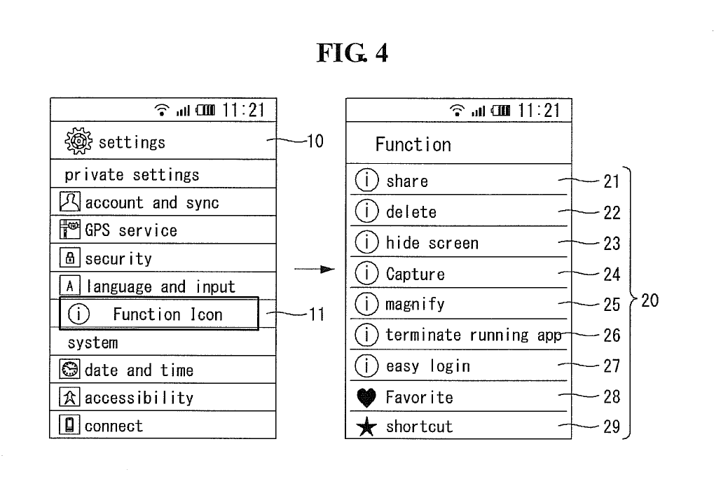

FIG. 3 is a flowchart illustrating a method for controlling the mobile terminal in accordance with a first exemplary embodiment of the present invention. FIGS. 4 to 9d are views for explaining the method for controlling a mobile terminal in accordance with the first exemplary embodiment of the present invention. The controlling method may be implemented under control of the controller 180 of the mobile terminal 100 described with reference to FIG. 1.

Referring to FIG. 3, the controller 180 of the mobile terminal 100 may create an object with a given attribute (S110).

The attribute may correspond to at least one function that can be implemented on the mobile terminal 100. For example, the attribute may include at least one of the functions including transferring a particular file, deleting a particular file, magnifying an area within a specific range of the touchscreen, recording the user's voice, saving as favorite, saving as shortcut, capturing, terminating the currently running application, and blocking (curtaining) the display seen on the touchscreen 151 to keep other people from peeking.

The object may be provided in the form of an icon mapped with this attribute.

The object mapped with this particular attribute may be stored in the memory 160 of the mobile terminal 100.

Meanwhile, the controller 180 may create an object with the attribute and store it in the memory 160, by selecting items related to the above-mentioned attribute in the mode for setting up the operating environment of the mobile terminal 100.

Also, the controller 180 may display a screen related to a particular item and an object mapped with a given attribute on the touchscreen 151 (S120).

The particular item may include a web browser, a phonebook, an SNS application, a given text file, multimedia content, and so on.

The screen related to the particular item may include an execution screen of the particular item or a screen related to the execution of the particular item. The screen related to the execution of the particular item may include the screen shown before execution of the particular item and any screen appearing on the touchscreen after execution of the particular item.

For example, if the particular item is a web browser, the screen related to the particular item may include a web page displayed on the touchscreen 151.

For example, if the particular item is an SNS application, the screen related to the particular item may include a login screen for connecting to the SNS application or a screen appearing after connecting to the SNS application.

For example, if the particular item is multimedia content, the screen related to the particular item may include a still image or video execution screen.

That is, a screen related to a particular item in the exemplary embodiment of the present invention may include any screen appearing on the touchscreen 151 of the mobile terminal 100.

Meanwhile, the controller 180 may display the object mapped with a given attribute as well when displaying the screen related to the particular item on the touchscreen 151.

In this case, when the screen related to the particular item is displayed on the touchscreen 151, the controller 180 may display at least one object mapped with an attribute applicable to the particular item as well. The object may be provided by displaying an object list on the touchscreen 151 so as to allow the user to select one of the at least one object.

When the screen related to the particular item is displayed on the touchscreen 151, the controller 180 may monitor the usage of particular attributes when the particular item is executed. By taking the usage into account, an object mapped with an optimum attribute may be automatically displayed on the screen related to the particular item.

The controller 180 may set at least one attribute applicable to each item in the form of a lookup table in advance and store it in the memory 160. The controller 180 may display the screen (e.g., item execution screen) related to the particular item on the touchscreen 180, and display a particular object on the screen related to the particular item with reference to the lookup table.

For example, when the screen related to the particular item is displayed on the touchscreen 151, the controller 180 may display the object on the touchscreen 151 by entering a hard key on the body of the mobile terminal 100 or a soft key displayed on the touchscreen 151.

For example, when the screen related to the particular item is displayed on the touchscreen 151, the controller 180 may display the object on the touchscreen 151 upon receiving a long touch input in one area of the touchscreen 151.

The controller 180 may receive a touch input for associating the object with the particular item (S130).

The controller 180 may apply the given attribute to the screen related to the particular item (S140).

The touch input for associating the object with the particular item may include an input for touching the object displayed on the screen related to the particular item and dragging it in a predetermined direction.

For example, a particular web page and an object with the favorite attribute may be displayed on the touchscreen 151. The controller 180 may display the object in a predetermined area of the web page. The predetermined area may be the upper or lower corner of the touchscreen 151. Also, upon receiving an input for dragging the object to the center of the web page, the controller 180 may apply the favorite attribute mapped in the object to the web page. By doing so, the controller 180 may add the web page to bookmarks.

The controller 180 may apply different attributes to the same object according to item type, depending on the type of the screen related to the particular item displayed along with the object.

For example, when the object with the favorite attribute is displayed on a call list screen, unlike when the object with the favorite attribute is displayed on a web page, a predetermined abbreviated dialing number may be designated for a telephone number in the call list associated with the object.

FIGS. 4 to 9b are views for explaining the method for controlling the mobile terminal in accordance with the first exemplary embodiment of the present invention.

FIG. 4 is a view illustrating a screen configuration for creating an object mapped with a particular attribute through the environment setup menu of the mobile terminal.

Referring to FIG. 4, the controller 180 in accordance with an exemplary embodiment of the present invention may generate an object (function icon), and map any one of the functions (or attributes) including the share function 21, the delete function 22, the hide screen function 23, the capture function 24, the magnify function 25, the terminate running application function, the easy login function 27, the favorite function 28, and the shortcut function 29.

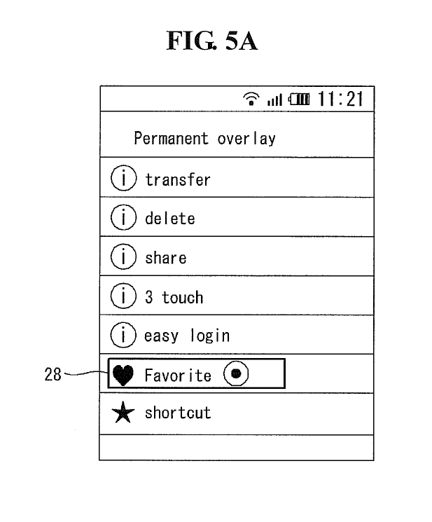

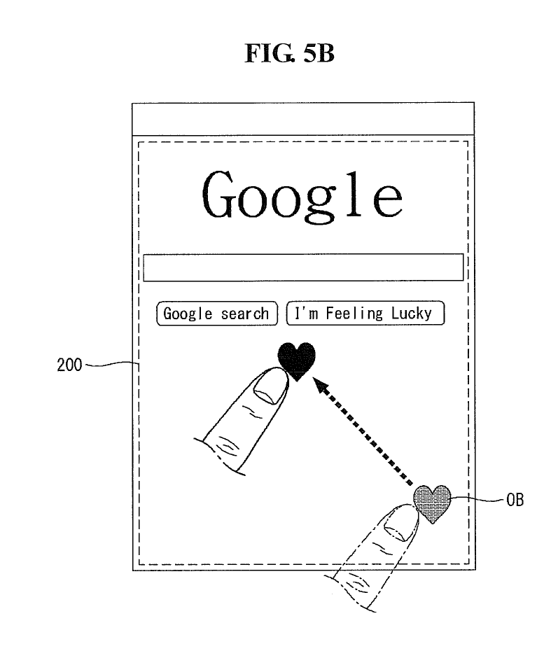

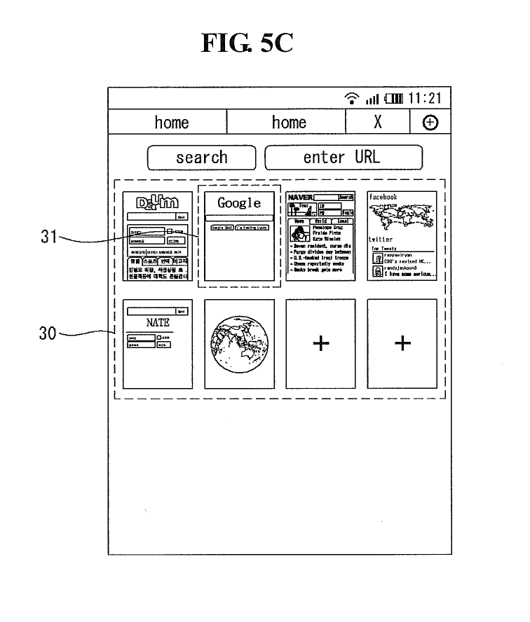

FIGS. 5A to 5C are views for explaining the case where the particular item is a web browser and the attribute mapped in the object is the favorite function.

A predetermined object may be mapped with the favorite attribute 28 (FIG. 5A), and the object OB mapped with the favorite attribute may be displayed on a predetermined web page 200.

Upon receiving a touch input for moving the object OB on the web page 200 to the center, the controller 180 may add the web page 200 to bookmarks 30. The controller 180 may display a thumbnail image of the web page to be added to the bookmarks 30 on the list of bookmarks 30.

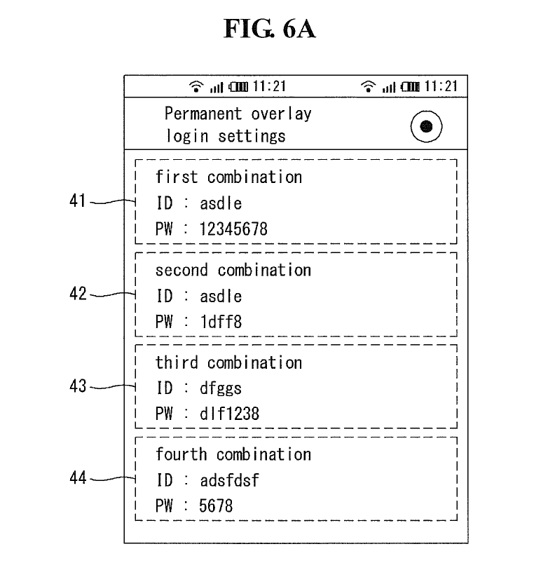

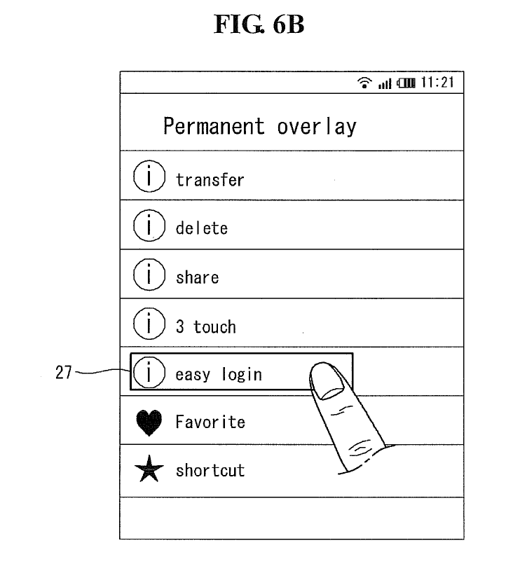

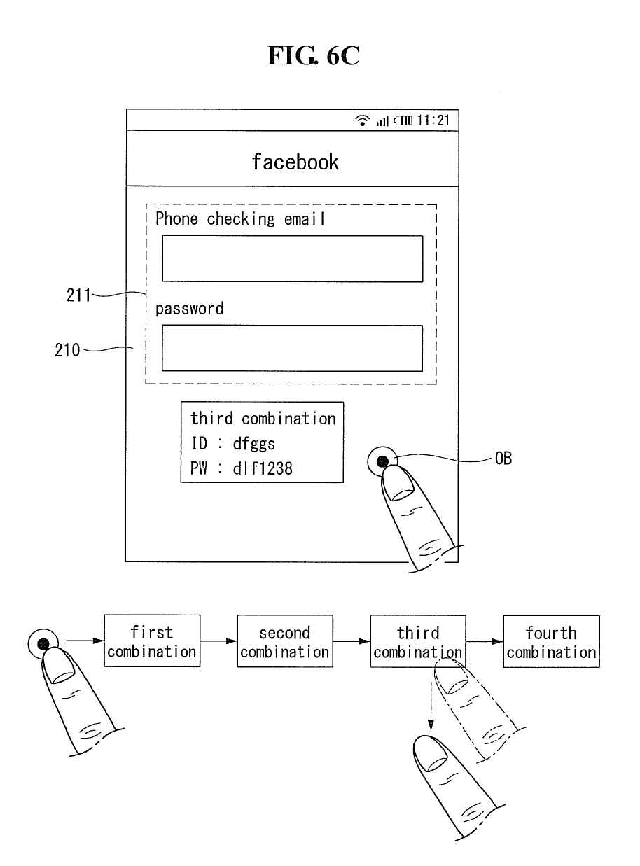

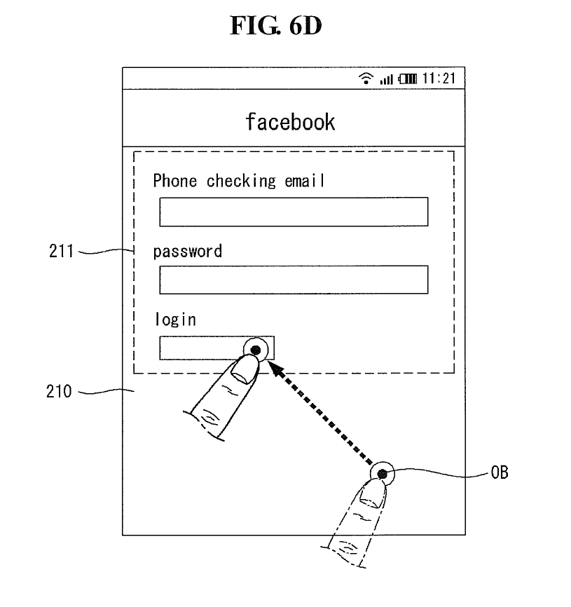

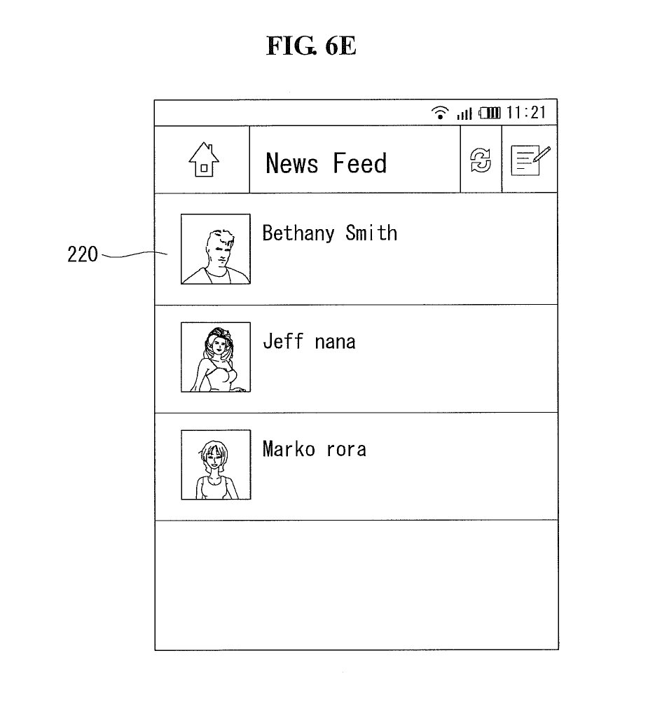

FIGS. 6A to 6E are views for explaining the case where the particular item is an SNS application and the attribute mapped in the object is the easy login function.

Referring to FIG. 6A, the user may set at least one login information consisting of an ID and a password in order to access a predetermined application. For example, the login information may include a first combination 41, a second combination 42, a third combination 43, and a fourth combination 44.

Referring to FIG. 6B, the easy login function (attribute) 27 may be mapped in the object related to the present invention.

Referring to FIG. 6C, a login screen 210 for executing an SNS application may be displayed on the touchscreen 151. The login screen 210 may include an area 211 for entering personal information. The area 211 for entering personal information receives data consisting of an ID and a password.

The controller 180 may sequentially display the combinations defined by the user on the touchscreen 151 while maintaining a touch input on the object OB. That is, the controller 180 may sequentially display a plurality of combinations of personal information while maintaining a touch input on the object mapped with the plurality of combinations of personal information, and select a corresponding combination of personal information when the touch input is released.

Referring to FIG. 6D, upon receiving a touch input for moving the object OB mapped with a selected combination of personal information to the area 211 for entering personal information or to the login area, the controller 180 may automatically log in by using the combination of personal information as the login information.

Referring to FIG. 6E, after automatically logging in, an SNS application access screen 220 may be displayed on the touchscreen 151.

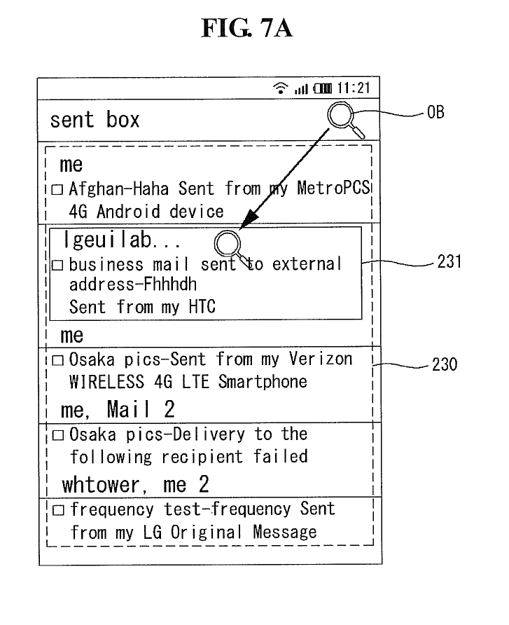

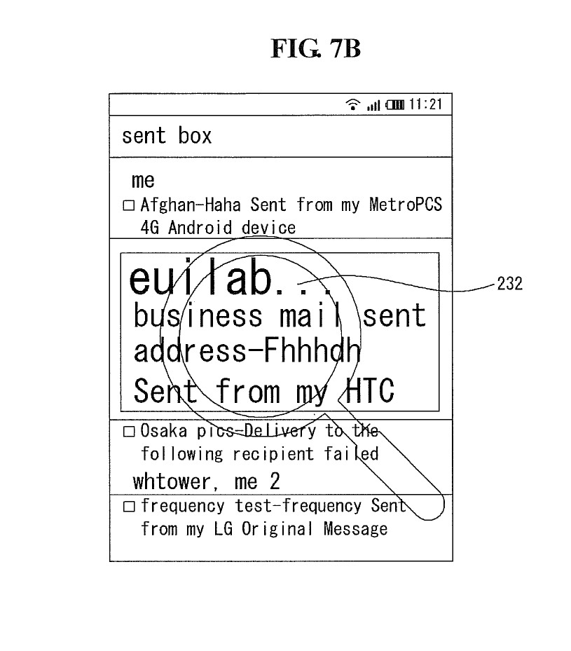

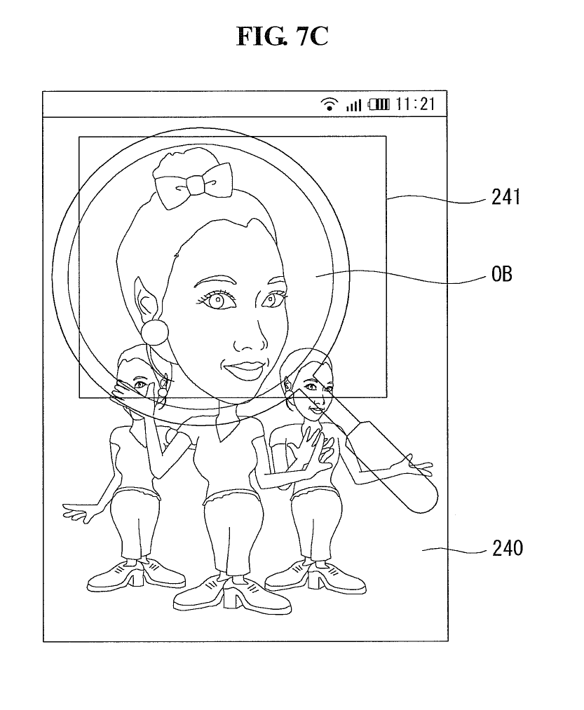

FIGS. 7A to 7C are views for explaining the case where the attribute mapped in the object is the magnify function.

Referring to FIG. 7A, the controller 180 may display a data list 230 containing a plurality of data items on the touchscreen 151. Also, the controller 180 may display the object OB mapped with the magnify function (attribute) on the touchscreen 151. Upon receiving a touch input for moving the object OB to a particular data item 231 among the plurality of data items, the controller 180 may magnify and display the data item 231, as shown in FIG. 7B.

Referring to FIG. 7C, the particular item may be an image 240. Upon receiving a touch input for moving the object OB to a particular area 241 on the image, the controller 180 may magnify and display the particular area.

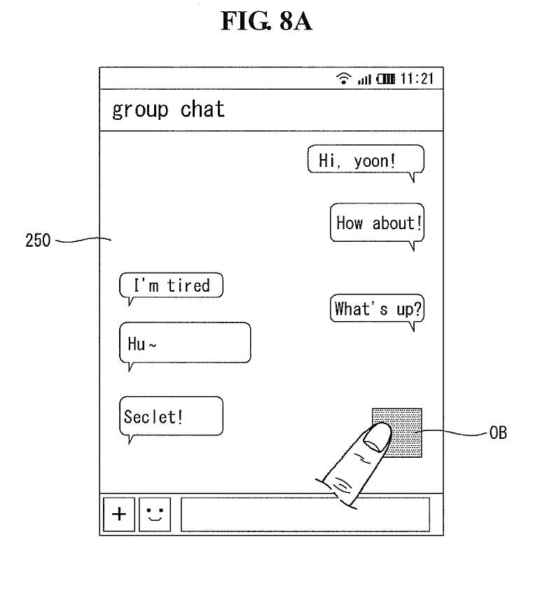

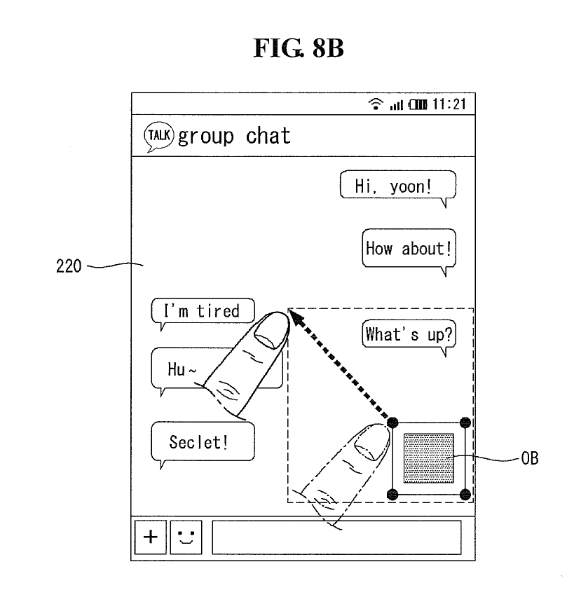

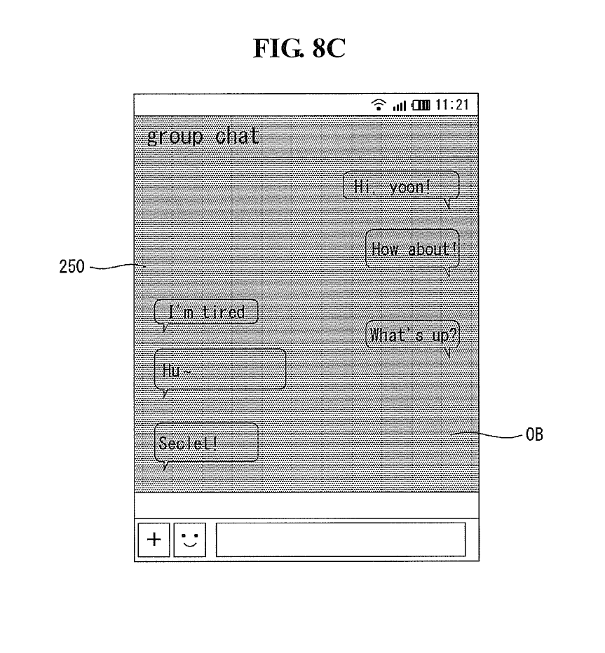

FIGS. 8A to 8C are views for explaining the case where the attribute mapped in the object is the hide screen function.

Referring to FIGS. 8A to 8C, a screen 250 for displaying sent and received messages may be displayed on the touchscreen 151. Upon receiving a touch input (e.g., a long touch input on the corner of the object) for enlarging the object OB (FIG. 8A), the controller 180 may enter an edit mode for resizing the object OB.

Afterwards, upon receiving a drag input for dragging a corner point of the object OB in a diagonal direction, the controller 180 may magnify the object OB mapped with the hide screen attribute along the drag trail (FIG. 8B).

The controller 180 may receive a drag input for fully hiding the entire message input screen 250 (FIG. 8C). Accordingly, the hide screen attribute may be applied to the message input screen 250. In this case, the message input screen 250 may not be visible to the third party other than the user viewing the touchscreen 151 of the mobile terminal 100 from the front.

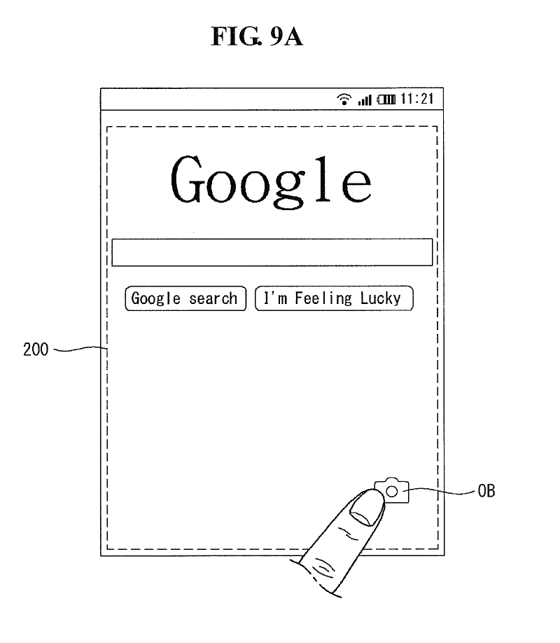

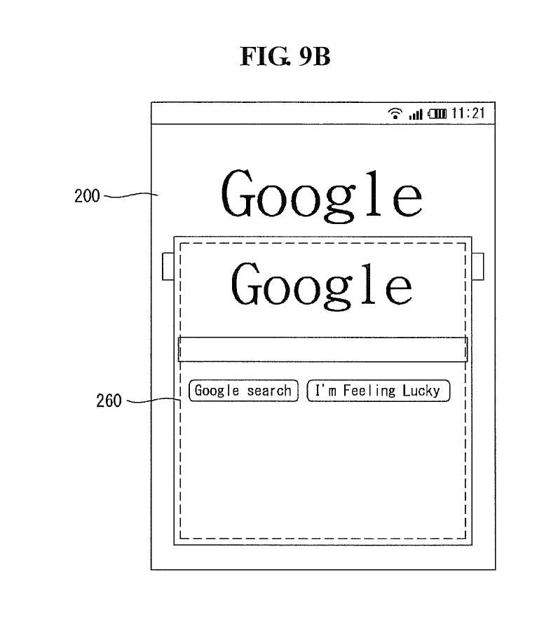

FIGS. 9A to 9B are views for explaining the object mapped with the screen capture attribute.

Referring to FIG. 9D, the controller 180 may set the screen capture attribute for a predetermined object OB. Also, the object OB mapped with this attribute may be set to be always displayed on the screen. Accordingly, the controller 180 may continue to display the object OB mapped with the screen capture attribute in an area of a predetermined web page 200 while performing the operation of displaying the web page 200 on the touchscreen 151.

Referring to FIG. 9B, upon receiving an input for selecting the object mapped with the screen capture attribute, the controller 180 may capture the web page screen 200 by the object OB and display the captured web page screen 260 on the touchscreen 151, without an additional input (e.g., input using a combination of at least one of the hard keys and soft keys of the mobile terminal 100) for performing the screen capture function on the web page 200 displayed on the touchscreen 151. Meanwhile, the controller 180 may control the captured web page screen 260 to be displayed on a smaller scale on the touchscreen 151 for a predetermined period of time and disappear, in order to notify the user of the execution of the capture function on the web page screen 200.

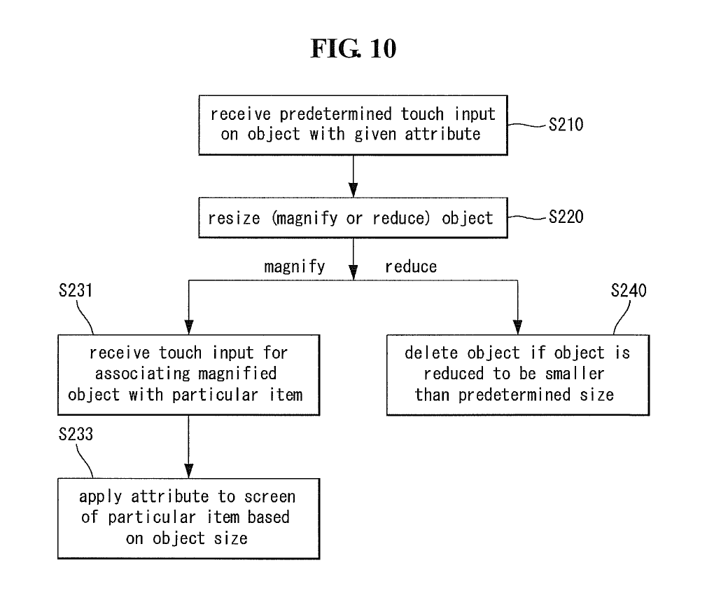

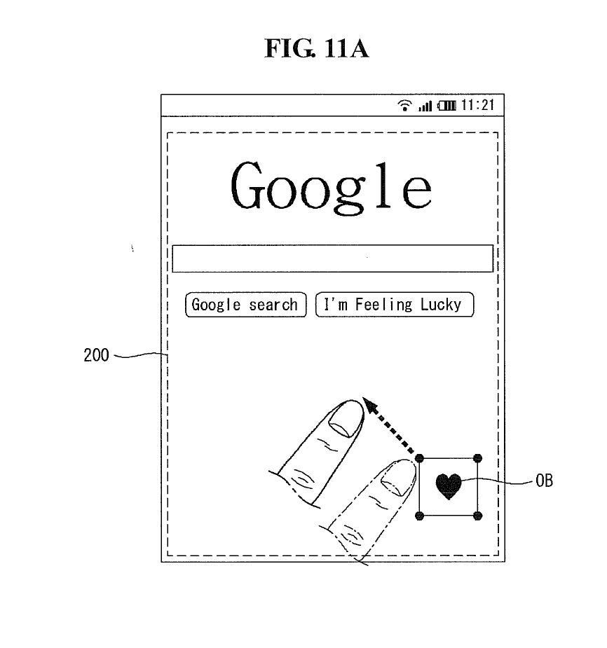

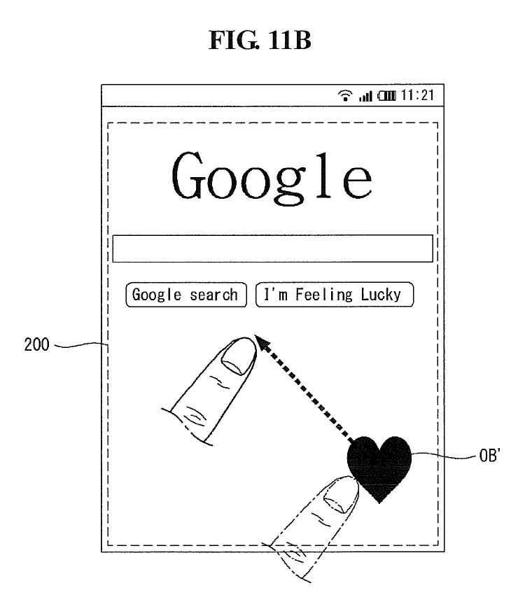

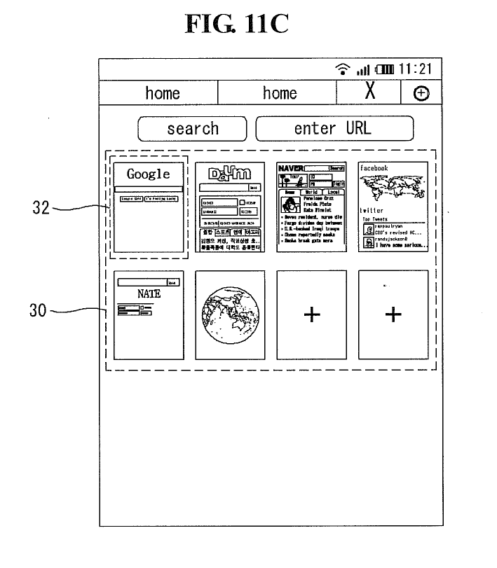

FIG. 10 is a flowchart of a method for controlling the mobile terminal in accordance with a second exemplary embodiment of the present invention. FIGS. 11A to 11C are views for explaining the method for controlling the mobile terminal in accordance with the second exemplary embodiment of the present invention. The control method may be implemented under control of the controller 180 of the mobile terminal 100 shown in FIG. 1. Also, the second exemplary embodiment may be carried out based on the foregoing first exemplary embodiment.

Referring to FIG. 10, the controller 180 may receive a predetermined touch input on an object with a given attribute (S210).

The predetermined touch input is a touch input for entering the mode of editing the appearance of the object, and may include a long touch input on the object. Upon receiving a long touch input, the controller 180 may resize the object. Upon receiving an input for touching a corner point of the object and dragging it in a particular direction, the controller 180 may magnify or reduce the object so as to correspond to the drag direction (S220).

Referring to FIGS. 11A and 11B, when the object OB mapped with the favorite attribute is displayed on a website screen, the controller 180 may magnify the object by dragging one corner of the object. The magnified object OB′ may be displayed as shown in FIG. 11B.

Once the object is magnified by the predetermined touch input, the controller 180 may receive a touch input for associating the magnified object with a particular item (S231).

Afterwards, the controller 180 may apply the attribute of the object to the screen of the particular item based on the size of the object (S233).

For example, referring to FIG. 11C, when the object mapped with the favorite attribute is displayed on the website screen, the object is magnified as much as possible. After that, upon receiving an input for dragging the object to an area of the website screen, the website may be saved as a bookmark with the highest priority for execution among all the bookmarks.

Also, if the object is reduced to be smaller than a predetermined size by the predetermined touch input, the controller 180 may delete the object (S240).

In accordance with the second exemplary embodiment of the present invention, after the object is magnified or reduced by editing its size, the resized object on the screen related to the particular item may be repositioned. For example, the larger the object, the higher on the screen related to the particular item the controller 180 may place the object.

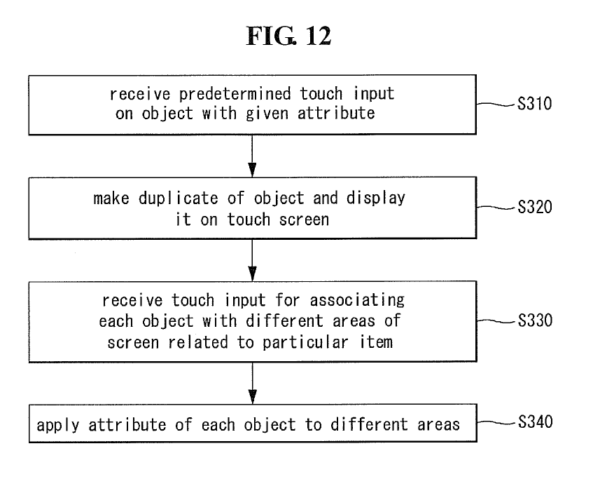

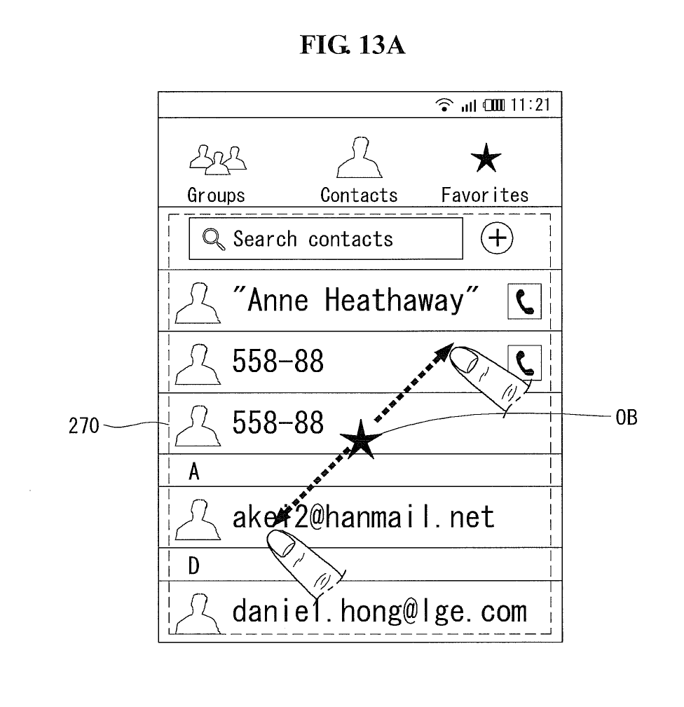

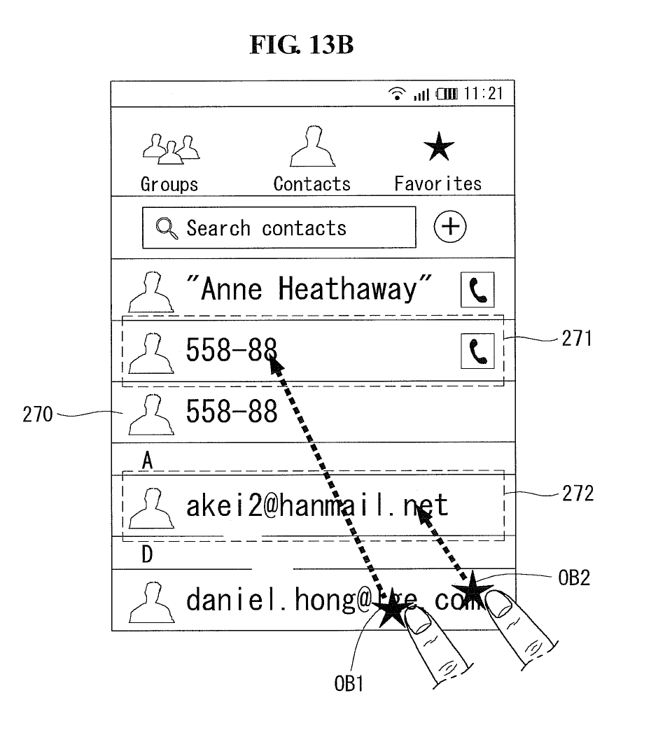

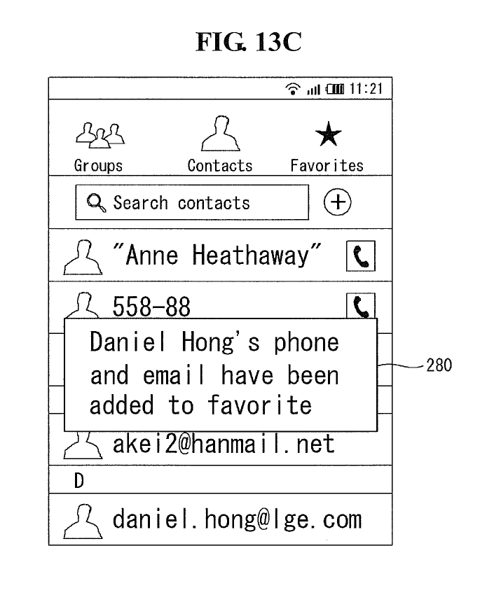

FIG. 12 is a flowchart of a method for controlling the mobile terminal in accordance with a third exemplary embodiment of the present invention. FIGS. 13A to 13C are views for explaining the method for controlling the mobile terminal in accordance with the third exemplary embodiment of the present invention. The control method may be implemented under control of the controller 180 of the mobile terminal 100 shown in FIG. 1. Also, the third exemplary embodiment may be carried out based on the foregoing first and second exemplary embodiments.

The mobile terminal 100 in accordance with the third exemplary embodiment of the present invention may display a plurality of objects with different attributes on a screen related to a particular item. Afterwards, if the plurality objects are associated with the screen related to the particular item, the plurality of different attributes may be applied to the single item.

Referring to FIG. 12, the controller 180 may receive a pinch zoom-in input on an object with a given attribute (S310).

Referring to FIGS. 13A to 13C, when the object OB with the favorite attribute is displayed on a screen that displays a phonebook list, the controller 180 may duplicate the same object and display a first object OB1 and a second object OB2, upon receiving a zoom-in input on the object OB (S320).

Afterwards, upon receiving a drag input for associating the first object OB1 with a first data list 271 and a drag input for associating the second object OB2 with a second data list 272 (S330), the controller 180 may apply the favorite attribute mapped in the first object OB1 and the second object OB2 to the first data list 271 and the second data list 272 (S340).

The controller 180 may register the first data list 271 (phone number of A) and the second data list 272 (email address of A) as favorites, and display a popup window 280 for notifying the user of the registration on the touchscreen 151.

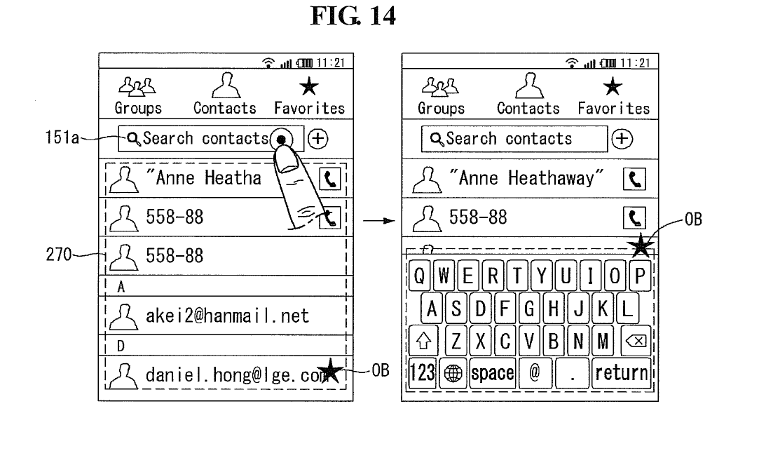

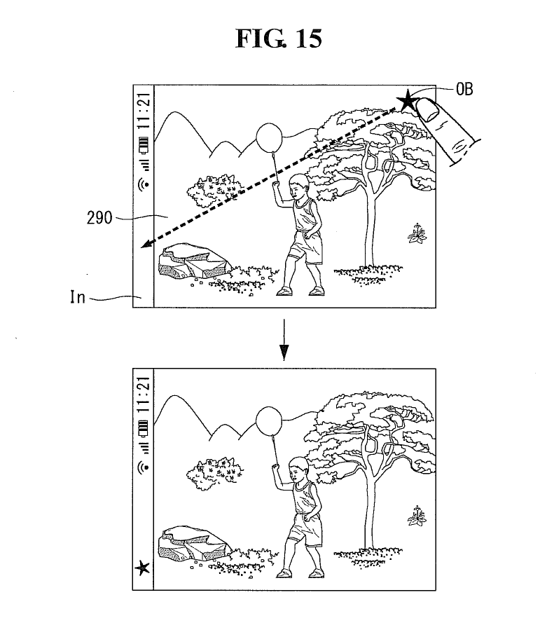

FIGS. 14 and 15 are views for explaining an example of repositioning an object in accordance with an exemplary embodiment of the present invention.

The mobile terminal 100 in accordance with an exemplary embodiment of the present invention may change the relative position of an object mapped with a predetermined function (attribute) on the screen related with a particular item.

For example, referring to FIG. 14, the touchscreen 151 may include a display area of the data list 270 and an input area 151a, and the object OB may be placed at the lower side of the data list 270.

Upon receiving a touch input on the input area 151a, the controller 180 may display a keypad on the lower side of the touchscreen 151, and rearrange the object OB at the top of the keypad.

Accordingly, even if the screen related to the particular item is changed, the controller 180 may control the object mapped with the particular attribute to be always displayed on the touchscreen 151.

Referring to FIG. 15, the controller 180 may fully display a screen for playing video content on the touchscreen 151, and display an object OB mapped with a particular attribute on the video content playback screen.

Upon receiving a drag input for moving the object OB to an indicator area In of the touchscreen 151, the controller 180 may reduce the size of the object OB and hide the object OB in the indicator area In.

Upon receiving a drag input for moving the object positioned in the indicator area In to the touchscreen 151, the controller 180 may position the object OB back on the screen related to the particular item.

As broadly described and embodied herein, a mobile terminal may include a touchscreen and a controller configured to control operation of the mobile terminal based on inputs at the touchscreen. A screen that includes at least one object for an application program may be displayed on the touchscreen, a graphical object associated with a prescribed function may be displayed on the touchscreen, and in response to a prescribed touch input that associates the graphical object with the application program object, the prescribed function may be performed for the application program object.

The application program may include at least one of multimedia player, a web browser, a phonebook, an SNS application, a photo viewer, a text editor, or an operating system of the mobile terminal, and the application program object includes at least one of a multimedia content, a hyperlink, a text input field, a search window, a phone number, a text message, a photo, a text string, or a screen image corresponding to the application program.

The screen may be an execution screen of the application program or a screen related to the execution of the application program, wherein the screen related to the execution of the application program includes at least one of a web page, a phonebook list, a login screen for connecting to the SNS application, a still image, or a video image. Moreover, the prescribed function may include a transfer function, a delete function, a share function, magnify function, a voice recording function, a login function, a form-fill function, an add favorites function, an add shortcut function, an add contacts function, a capture image function, a zoom function, a terminate application function, or a hide screen functions.

The graphical object associated with the prescribed function may be an icon for the prescribed function. The prescribed function associated with the graphical object may be set by a user among a plurality of functions. Moreover, an image of the graphical object may be changed according to the associated function.

The graphical object may be displayed simultaneously with the screen for the application program object or the graphical object may be displayed in response to a prescribed input while the screen is already displayed. The prescribed input to display the graphical object may include at least one of an input at a hard key on the mobile terminal, an input at a soft key on the touchscreen, or a long touch input on the screen. The controller may be configured to reposition the graphical object on the touchscreen when a configuration of the screen or the application program object is changed.

The graphical object may be resized based on a prescribed input on the graphical object to resize the graphical object. The function associated with the graphical object may be changed based on the size of the graphical object. The controller may be configured to generate at least one copy of the graphical object in response to a first touch input on the graphical object, and to delete the copy of the graphical object in response to a second touch input on the copy of the graphical object. The controller may be configured to perform the function associated with the graphical object to a second application program object on the screen in response to an input to associate the copy of the graphical object with the second application program object.

Moreover, the controller may be configured to display a list containing at least one graphical object applicable to the application program object, wherein the graphical objects are listed based on a type of the application program object. The controller may be configured to continue to display the graphical object even when the screen is changed to another screen associated with another application program.

In one embodiment, a method for controlling the mobile terminal may include displaying a screen for an application program that includes at least one object for an application program, displaying a graphical object associated with a prescribed function, receiving a touch input that associates the graphical object with the application program object, and applying the prescribed function to the screen related to the application program object. The method may further include setting an attribute for the graphical object.

Moreover, the screen may be at least one of a web page, a phonebook list, a login screen, a multimedia viewer, a text messaging screen, or an address book, and the graphical object is an icon associated with the prescribed function, wherein the prescribed function is at least one of a transfer function, a delete function, a share function, magnify function, a voice recording function, a login function, a form-fill function, an add favorites function, an add shortcut function, an add contacts function, a capture image function, a zoom function, a terminate application function, or a hide screen functions. The touch input for associating the graphical object with the application program object may be a touch-and-drag input to drag the graphical icon to the application program object.

As broadly described and embodied herein, a mobile terminal is provided which is capable of implementing various functions executable on mobile terminals through interaction with an object, and a method for controlling the same. Particularly, a mobile terminal is provided which associates at least one application executable on the mobile terminal with an object mapped with a given attribute to implement various functions of the application by allowing for easy manipulation of the object, and a method for controlling the same.

In one embodiment, a mobile terminal may include: a touchscreen; and a controller configured to display a screen related to a particular item and an object mapped with a given attribute on the touchscreen, and upon receiving a touch input for associating the object with the particular item, to apply the given attribute to the screen related to the particular item.

The particular item may include at least one of multimedia content, a web browser, a phonebook, an SNS application, and given text information.

The screen related to the particular item may include an execution screen of the particular item or a screen related to the execution of the particular item, and the screen related to the execution of the particular item may include at least one of a web page, a phonebook list, a login screen for connecting to the SNS application, a still image, and a video image.

The given attribute may include any one of transfer, delete, share, magnify, voice recording, easy login, favorite, shortcut, capture, terminate running application, and hide screen functions.

The function to be mapped in the object may include a function set by the user.

A GUI (graphic user interface) for identifying the object may be displayed, and the GUI may be configured to be displayed differently according to the mapped function.

The controller may be configured to display the object simultaneously with the screen related to the particular item or to display the object on the screen related to the particular item upon receiving a predetermined input when the screen related to the particular item is already displayed.

The predetermined input may include at least one of a hard key on the mobile terminal, a soft key on the touchscreen, and a long touch input on the screen related to the particular item.

The controller may be configured to reposition the object before displaying the same if the configuration of the screen related to the particular item is changed.

The controller may be configured to enter a mode for resizing the object upon receiving a predetermined input on the object.

The controller may be configured to make at least one duplicate of the object and display the same on the touchscreen upon receiving a first touch input on the object, and to delete the duplicate object upon receiving a second touch input.

The controller may be configured to apply the attribute of the object to different areas of the screen related to the particular item upon receiving a touch input for associating the different areas with a plurality of duplicate objects.

The controller may be configured to display a list containing at least one object applicable to the particular item on the touchscreen according to the type of the particular item.

The controller may be configured to continue to display the object even if the screen related to the particular item is changed.

A method for controlling the mobile terminal in accordance with another aspect of the present invention may include: displaying a screen related to a particular item and an object mapped with a given attribute on a touchscreen; receiving a touch input for associating the object with the particular item; and applying the given attribute to the screen related to the particular item.

A mobile terminal and a method for controlling the same in accordance with an exemplary embodiment of the present invention offer the following advantages.

According to the present invention, various functions executable on the mobile terminal can be implemented through interaction with an object.

According to the present invention, at least one application executable on the mobile terminal can be associated with an object mapped with a given attribute to implement various functions of the application by allowing for easy manipulation of the object.

The above-described method for controlling the mobile terminal according to the present invention may be stored in a recording medium that may be read by a computer program to be executed in a computer.

The method for controlling the mobile terminal according to the present invention may be implemented by software. When implemented by software, the components of each embodiment may be code segments, each executing a necessary operation. The program or code segments may be stored in a processor-readable medium or transmitted by computer data signals combined with a carrier through a transmission medium or over a communication network.

The computer-readable recording medium may include all types of recording devices that may store data read by a computer system. Examples of the computer-readable recording medium may include, but not limited to, ROMs, RAMs, CD-ROMs, DVD±ROMs, DVD-RAMs, magnetic tapes, floppy disks, hard disks, optical data storage, etc. Further, the computer-readable recording medium may store and execute a code that is distributed in computer devices interconnected over a network and readable by a computer in a distributed manner.

Embodiments of the present invention are not limited to the embodiments disclosed herein and the accompanying drawings. It will be apparent to those skilled in the art that various substitutions, modifications and changes can be made without departing from the technical spirit or scope of the present invention. Further, the embodiments described herein are not limiting, and all or some of the embodiments may be selectively combined so as to be modified in various ways.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the invention, the drawings and the appended claims. In addition to variations and modifications in the component parts and/or arrangements, alternative uses will also be apparent to those skilled in the art.

What is claimed is:

1. A mobile terminal comprising:
a touchscreen; and
a controller configured to control operation of the mobile terminal based on inputs at the touchscreen, wherein a screen that includes at least one object for an application program is displayed on the touchscreen, a graphical object associated with a prescribed function is displayed on the touchscreen, and in response to a prescribed touch input that associates the graphical object with the application program object, the prescribed function is performed for the application program object.

2. The mobile terminal of claim 1, wherein the application program includes at least one of multimedia player, a web browser, a phonebook, an SNS application, a photo viewer, a text editor, or an operating system of the mobile terminal, and the application program object includes at least one of a multimedia content, a hyperlink, a text input field, a search window, a phone number, a text message, a photo, a text string, or a screen image corresponding to the application program.

3. The mobile terminal of claim 1, wherein the screen is an execution screen of the application program or a screen related to the execution of the application program, wherein the screen related to the execution of the application program includes at least one of a web page, a phonebook list, a login screen for connecting to the SNS application, a still image, or a video image.

4. The mobile terminal of claim 1, wherein the prescribed function includes a transfer function, a delete function, a share function, magnify function, a voice recording function, a login function, a form-fill function, an add favorites function, an add shortcut function, an add contacts function, a capture image function, a zoom function, a terminate application function, or a hide screen functions.

5. The mobile terminal of claim 1, wherein the graphical object associated with the prescribed function is an icon for the prescribed function.

6. The mobile terminal of claim 1, wherein the prescribed function associated with the graphical object is set by a user among a plurality of functions.

7. The mobile terminal of claim 6, wherein an image of the graphical object is changed according to the associated function.

8. The mobile terminal of claim 1, wherein the graphical object is displayed simultaneously with the screen for the application program object or the graphical object is displayed in response to a prescribed input while the screen is already displayed.

9. The mobile terminal of claim 8, wherein the prescribed input to display the graphical object includes at least one of an input at a hard key on the mobile terminal, an input at a soft key on the touchscreen, or a long touch input on the screen.

10. The mobile terminal of claim 8, wherein the controller is configured to reposition the graphical object on the touchscreen when a configuration of the screen or the application program object is changed.

11. The mobile terminal of claim 1, wherein the graphical object is resized based on a prescribed input on the graphical object to resize the graphical object.

12. The mobile terminal of claim 1, wherein the function associated with the graphical object is changed based on the size of the graphical object.

13. The mobile terminal of claim 1, wherein the controller is configured to generate at least one copy of the graphical object in response to a first touch input on the graphical object, and to delete the copy of the graphical object in response to a second touch input on the copy of the graphical object.

14. The mobile terminal of claim 13, wherein the controller is configured to perform the function associated with the graphical object to a second application program object on the screen in response to an input to associate the copy of the graphical object with the second application program object.

15. The mobile terminal of claim 1, wherein the controller is configured to display a list containing at least one graphical object applicable to the application program object, wherein the graphical objects are listed based on a type of the application program object.

16. The mobile terminal of claim 1, wherein the controller is configured to continue to display the graphical object even when the screen is changed to another screen associated with another application program.

17. A method for controlling the mobile terminal, the method comprising:
displaying a screen for an application program that includes at least one object for an application program;
displaying a graphical object associated with a prescribed function;
receiving a touch input that associates the graphical object with the application program object; and
applying the prescribed function to the screen related to the application program object.

18. The method of claim 17, further comprising setting an attribute for the graphical object.

19. The method of claim 17, wherein the screen is at least one of a web page, a phonebook list, a login screen, a multimedia viewer, a text messaging screen, or an address book, and the graphical object is an icon associated with the prescribed function, wherein the prescribed function is at least one of a transfer function, a delete function, a share function, magnify function, a voice recording function, a login function, a form-fill function, an add favorites function, an add shortcut function, an add contacts function, a capture image function, a zoom function, a terminate application function, or a hide screen functions.

20. The method of claim 19, wherein the touch input for associating the graphical object with the application program object is a touch-and-drag input to drag the graphical icon to the application program object.
